(19) United States
(12) Patent Application Publication
(10) Pub. No.: US 2014/0314305 A1
(43) Pub. Date: Oct. 23, 2014

(54) TEMPLATE INSPECTION DEVICE

(71) Applicant: KABUSHIKI KAISHA TOSHIBA, Tokyo (JP)

(72) Inventor: Ryoji YOSHIKAWA, Yokohama-shi (JP)

(73) Assignee: KABUSHIKI KAISHA TOSHIBA, Tokyo (JP)

(21) Appl. No.: 14/178,450

(22) Filed: Feb. 12, 2014

(30) Foreign Application Priority Data
Apr. 18, 2013 (JP) 2013-087504

(51) Int. Cl. G06T 7/00; G01N 21/95

(52) U.S. Cl. CPC G06T 7/001; G01N 21/9503
USPC 382/149

(57) ABSTRACT

According to one embodiment, a template inspection device used in imprint lithography, comprises an inspection image data acquisition unit configured to acquire inspection image data of an inspection target replica template pattern based on a master template pattern; a comparison data generation unit configured to generate comparison data by comparing the inspection image data of the inspection target replica template pattern with corrected reference image data, and a defect determination unit configured to determine a defect in the inspection target replica template pattern based on the comparison data generated by the comparison data generation unit.

### CROSS-REFERENCE TO RELATED APPLICATIONS

This application is based upon and claims the benefit of priority from the prior Japanese Patent Application No. 2013-087504, filed Apr. 18, 2013, the entire contents of which are incorporated herein by reference.

### FIELD

Embodiments described herein relate generally to a template inspection device.

### BACKGROUND

To cope with fine patterning of semiconductor devices, imprint lithography (nanoimprint lithography) has been proposed.

In imprint lithography, the template gradually degrades along with an increase in the usage count. For this reason, normally, a plurality of replica templates are formed from a master template, and imprint lithography is performed using the replica templates.

When forming a replica template from the master template, the formed replica template needs to be inspected. In imprint lithography, since the size of the pattern formed, on the template is small, the size of a defect to be detected is also small. For this reason, a portion that is not a true defect, for example, line edge roughness (LER) may be determined as a defect.

Hence, an inspection device or inspection method capable of properly detecting only true defects is needed.

### BRIEF DESCRIPTION OF THE DRAWING

FIG. 1 is a block diagram showing the arrangement of a template inspection device according to the first embodiment;

FIG. 2 is a block diagram showing the arrangement of a computer shown in FIG. 1;

FIG. 3 is a flowchart showing a template inspection method according to the first embodiment;

FIG. 4 is a view showing an image of a master template;

FIG. 5 is a view showing an image of a defective replica template according to a comparative example;

FIG. 6 is a view showing an image of a defective replica template according to the first embodiment;

FIG. 7 is a block diagram showing the arrangement of a template inspection device according to the second, embodiment;

FIG. 8 is a flowchart showing a template inspection method according to the second embodiment;

FIG. 9 is a block diagram showing the arrangement of a template inspection device according to the third embodiment;

FIG. 10 is a view schematically showing the planar arrangement of a master template according to the third embodiment;

FIG. 11 is a view schematically showing the planar arrangement of a replica template according to the third embodiment;

FIG. 12 is a flowchart showing a template inspection method according to the third embodiment; and

FIG. 13 is a flowchart showing a semiconductor device manufacturing method.

### DETAILED DESCRIPTION

In general, according to one embodiment, a template inspection device used in imprint lithography, comprises an inspection image data acquisition unit configured to acquire inspection image data of an inspection target replica template pattern based on a master template pattern, the master template pattern being arranged on a master template and also arranged on an inspection target replica template obtained from the master template, a comparison data generation unit configured to generate comparison data by comparing the inspection image data of the inspection target replica template pattern with corrected reference image data, the corrected reference image data being obtained by correcting reference image data based on design data of the master template pattern using one of inspection data of the master template pattern and inspection data of a reference replica template pattern, and the reference replica template pattern being arranged on a reference replica template obtained from the master template and based on the master template pattern, and a defect determination unit configured to determine a defect in the inspection target replica template pattern based on the comparison data generated by the comparison data generation unit.

The embodiments will now be described with reference to the accompanying drawing.

### First Embodiment

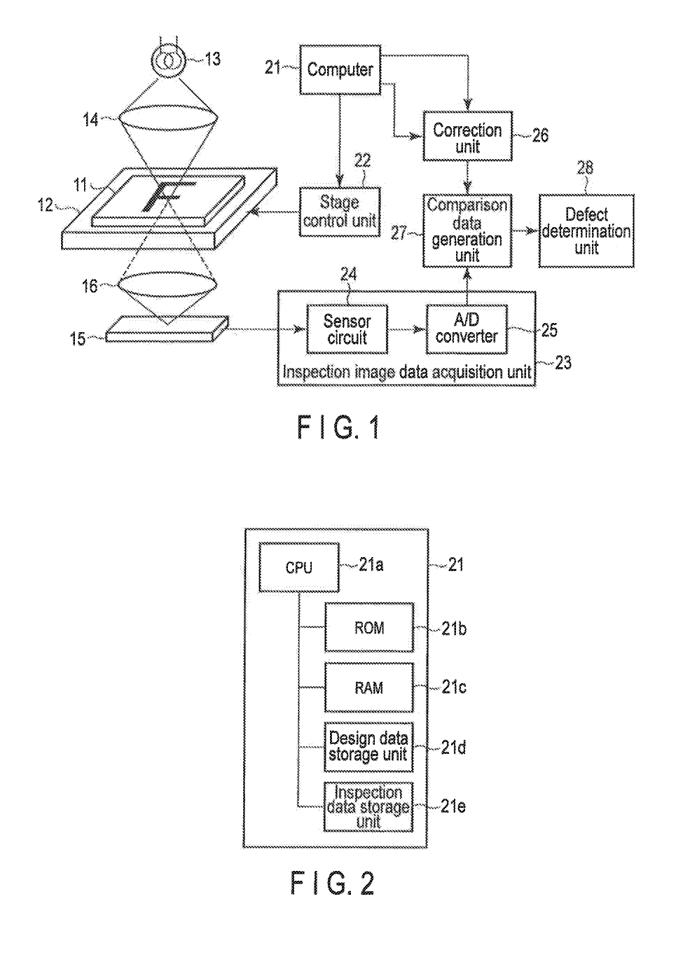

FIG. 1 is a block diagram showing the arrangement of an inspection device according to the first embodiment. This inspection device is an inspection device of a template used for imprint lithography.

A template 11 that is a measurement target is placed on a stage 12. A light source 13 is arranged above the stage 12. A mercury lamp, an argon laser, or the like is used as the light source 13. Light from the light source 13 enters the template 11 placed on the stage 12 via a condenser lens 14. An image sensor 15 is arranged under the stage 12. The light transmitted through the template 11 enters the image sensor 15 via an objective lens 16. The light source 13, the condenser lens 14, the image sensor 15, and the objective lens 16 constitute an image capturing unit that captures a template pattern formed on the template 11.

A CCD sensor including one- or two-dimensionally arrayed pixels is usable as the image sensor 15. When the stage 12 is moved in the X and Y directions, the image sensor 15 can acquire the image of the entire template pattern of the template 11 placed on the stage 12. The template pattern image of the template 11 is enlarged to several hundred times by the optical system (condenser lens 14, objective lens 16, and the like) and formed on the image sensor 15. Note that not only the transmitted light but also reflected light may be caused to enter the image sensor 15 in accordance with the characteristic of the template 11. Mixed light of the transmitted light and reflected light may be caused to enter the image sensor 15.

FIG. 2 is a block diagram showing the arrangement of a computer 21. The computer 21 includes a CPU 21a, a ROM 21b, a RAM 21c, a design data storage unit 21d, and an inspection data storage unit 21e.

The CPU 21a controls the units of the device and performs arithmetic processing. The ROM 21b stores the control programs and arithmetic processing programs of the device. The RAM 21c temporarily stores data.

The design data storage unit 21d stores the design data of a master template pattern arranged on a master template.

The inspection data storage unit 21d stores the inspection data (master template pattern inspection data) of a master template pattern arranged on a master template.

The inspection data of the master template pattern includes data associated with line edge roughness (LER) of a circuit pattern included in the master template pattern. In the template pattern, roughness occurs at the edges of the pattern at the template pattern forming stage. In imprint lithography, since the size of the pattern formed on the template is small, the size of a defect to be detected is also small. For this reason, a portion that is not a true defect, for example, line edge roughness may be determined as a defect. To prevent the device from determining line edge roughness as a defect, data associated with line edge roughness is extracted as inspection data.

Data associated with line edge roughness can be obtained, for example, in the following way. First, the image of the master template pattern is acquired. The image of the master template pattern can be acquired by the image capturing unit shown in FIG. 1 or another image capturing unit. The difference between the image of the master template pattern and the image of an ideal master template pattern without line edge roughness is obtained. The ideal master template pattern can be obtained by performing filter processing for the design data of the master template pattern. The filter processing is processing reflecting prediction of an optical pattern image to be captured by the image capturing unit as well as a pattern variation caused by the lithography process or etching process upon forming the template pattern on the pattern directly obtained from the design data.

The data associated with line edge roughness obtained in the above-described manner is stored in the inspection data storage unit 21e as the inspection data of the master template pattern. The data associated with line edge roughness includes roughness data and position data of line edge roughness. That is, position data and corresponding roughness data are stored in the inspection data storage unit 21e.

A stage control unit 22 is connected to the computer 21. When the stage 12 is moved in two axis directions (X and Y directions) under the control of the stage control unit 22, the stage 12 can be moved to a desired position.

An inspection image data acquisition unit 23 acquires inspection image data of an inspection target replica template pattern arranged on an inspection target replica template. More specifically, the image sensor 15 captures an image of the inspection target replica template 11 placed on the stage 12. The image data of the inspection target replica template pattern captured by the image sensor 15 is obtained as inspection image data. The replica template is obtained from the master template and provided with the replica template pattern based on the master template pattern. That is, the replica template is provided with the replica template pattern duplicated from the master template pattern.

The inspection image data acquisition unit 23 includes a sensor circuit 24 and an A/D converter 25. The sensor circuit 24 outputs the optical image (sensor image) of the inspection target replica template pattern obtained from the image sensor 15. The pixel size of the sensor image is, for example, 50 nm×50 nm. The A/D converter 25 converts the analog signal of the sensor image from the sensor circuit 24 into a digital signal.

A correction unit 26 corrects reference image data based on the design data stored in the design data storage unit 21d using the master template pattern inspection data stored in the inspection data storage unit 21e. More specifically, the design data stored in the design data storage unit 21d is first sent to a pattern rasterization circuit and rasterized into binary or multivalued tone data having almost the same resolution as the image sensor 15. In addition, the above-described filter processing is applied. That is, processing reflecting prediction of an optical pattern image to be captured by the image capturing unit as well as a pattern variation caused by the lithography process or etching process upon forming the template pattern on the pattern-rasterized design data is applied. The data that has undergone the filter processing is sent to the correction unit 26 as reference image data. The size of the reference image is the same (50 nm×50 nm) as the pixel size of the sensor image. The correction unit 26 corrects the above-described reference image data using the master template pattern inspection data stored in the inspection data storage unit 21e. By this correction processing, corrected reference image data is generated.

A comparison data generation unit 27 compares the inspection image data of the inspection target replica template pattern with the above-described corrected reference image data, thereby generating comparison data. More specifically, the comparison data generation unit 27 generates difference image data between the inspection image data of the inspection target replica template pattern output from the inspection image data acquisition unit 23 and the corrected reference image data output from the correction unit 26.

A defect determination unit 28 determines a defect in the inspection target replica template pattern based on the comparison data (difference image data) generated by the comparison data generation unit 27. That is, a portion where a difference of a predetermined value or more is generated between the corrected reference image data and the inspection image data of the inspection target replica template pattern is determined as a defect. Since the replica template is a replica of the master template, line edge roughness of the master template pattern is reflected on the replica template pattern as well. Hence, if the replica template has no defect, the inspection image data of the inspection target replica template pattern should match the corrected reference image data. For this reason, a portion where the data do not match (a portion where a difference of a predetermined value or more is generated) can be determined as a defective portion.

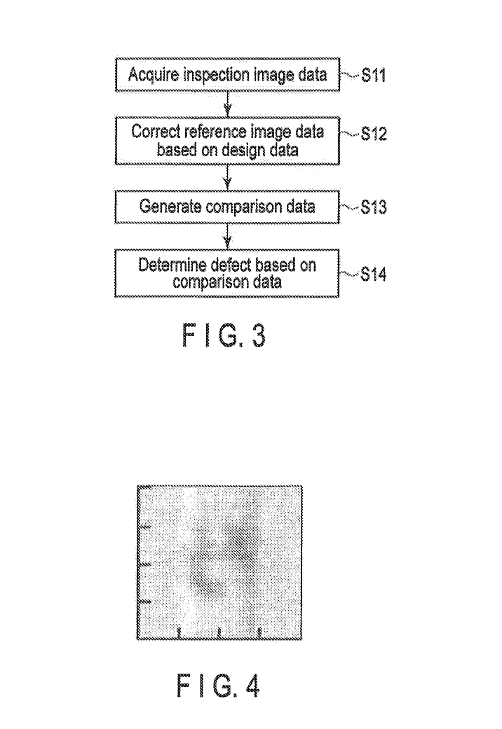

A template inspection method according to this embodiment will be described next with reference to the flowchart of FIG. 3. This inspection method is executed using the inspection device shown in FIGS. 1 and 2.

Before inspection, it is judged whether master template inspection data is stored in the inspection data storage unit 21e. If master template inspection data is not stored, normal inspection is executed. If master template inspection data is stored in the inspection data storage unit 21e, the inspection operation is executed in accordance with the flowchart of FIG. 3.

First, the image sensor 15 captures the image of the template pattern of the inspection target replica template 11 placed on the stage 12, and the inspection image data acquisition unit 23 acquires inspection image data from the captured image (step S11).

Reference image data based on the design data of the master template pattern stored in the design data storage unit 21d is corrected using the master template pattern inspection data (that is, data associated with line edge roughness of the master template) stored in the inspection data storage unit 21e, thereby generating corrected reference image data (step S12).

The comparison data generation unit 27 compares the inspection image data obtained in step S11 with the corrected reference image data obtained in step S12, thereby generating comparison data (step S13).

The defect determination unit 28 determines a defect in the inspection target replica template pattern 11 based on the comparison data generated by the comparison data generation unit 27 (step S14).

Note that the processes of steps S11 to S13 may be performed in parallel. That is, while moving the inspection position of the template pattern of the inspection target replica template 11, corrected reference image data corresponding to the moved inspection position is output from the correction unit 26, and comparison data between the inspection image data and the corrected reference image data at the moved inspection position is generated. The comparison data may be generated while moving the inspection position in the above-described way.

As described above, in this embodiment, since defect inspection of the replica template is performed in consideration of an element such as line edge roughness that is not a true defect but may be determined as a defect, only true defects can properly be detected. That is, since defect determination is performed in a state in which an element such as line edge roughness that is not a true defect but may be determined as a defect is mostly excluded, only true defects can reliably be detected.

The corrected reference image data to be compared, with the inspection image data of the replica template pattern is generated from the design data of the master template and the inspection data of the master template (in this embodiment, data associated with line edge roughness). Hence, since it is unnecessary to store the image data of the entire image of the master template pattern, the stored data amount can be reduced.

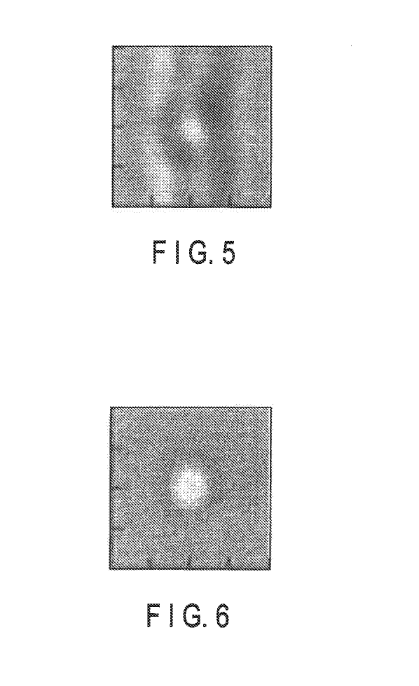

FIGS. 4, 5, and 5 are views showing the above-described effects. FIG. 4 illustrates an image of a master template. FIG. 5 illustrates an image of a defective replica template according to a comparative example. FIG. 6 illustrates an image of a defective replica template according to this embodiment. In the comparative example shown in FIG. 5, a true defect is difficult to discriminate because of line edge roughness. To the contrary, in this embodiment shown in FIG. 6, the influence of line edge roughness is eliminated, and only a true defect is extracted.

Note that in the above-described embodiment, the inspection data of the master template is used as the inspection data (data associated with line edge roughness) stored in the inspection data storage unit 21e. However, a replica template other than the inspection target replica template may be used as a reference replica template in place of the master template, and inspection data of the reference replica template may be used. The reference replica template is also a replica of the master template, and therefore has line edge roughness that almost matches the line edge roughness of the master template. Hence, even when the reference replica template is used in place of the master template, the same device and method as in the above-described embodiment can be used by storing the inspection data (data associated with line edge roughness of the reference replica template pattern) of the reference replica template pattern in the inspection data storage unit 21e.

In the above-described embodiment, the correction unit 26 generates corrected reference image data based on the design data of the master template stored in the design data storage unit 21d and the inspection data of the master template stored in the inspection data storage unit 21e. However, corrected reference image data based on the design data of the master template and the inspection data of the master template may be created in advance, and the corrected reference image data created in advance may be stored in the computer 21. In this case, the corrected reference image data stored in the computer 21 is directly sent to the comparison data generation unit 27.

Alternatively, corrected, reference image data created in advance may be input from the outside of the template inspection device to the comparison data generation unit 27.

### Second Embodiment

The second embodiment will be described next. Note that the basic details are the same as in the first embodiment, and a description of the details described in the first embodiment will be omitted.

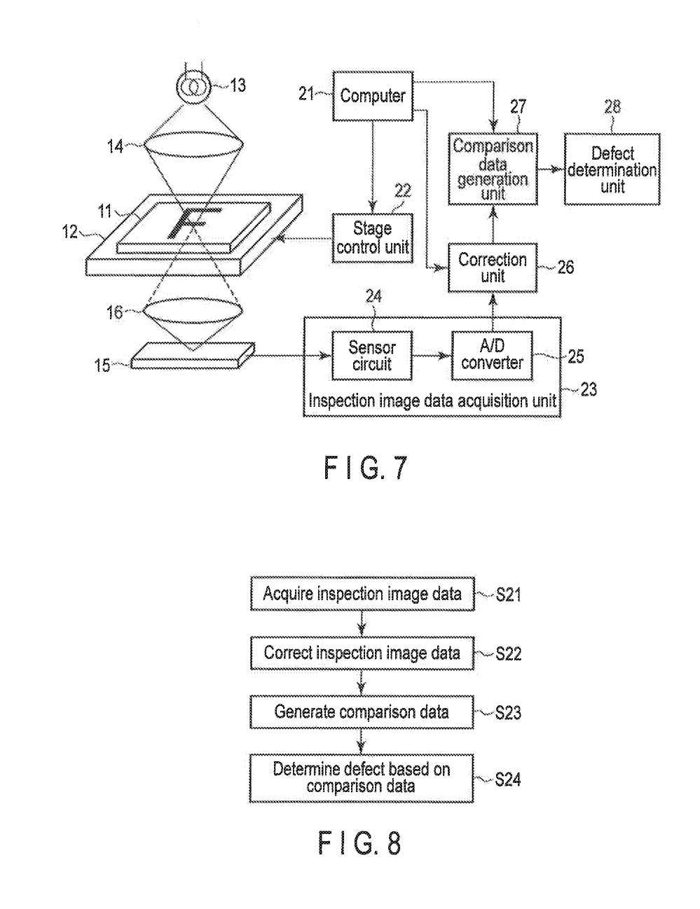

FIG. 7 is a block diagram showing the arrangement of an inspection device according to the second embodiment. Note that since the basic arrangement is the same as in FIG. 1 of the first embodiment, the same reference numerals as in the first embodiment denote constituent elements corresponding to those in the first embodiment, and a detailed description thereof will be omitted. In addition, since the basic arrangement of a computer 21 is the same as in FIG. 2 of the first embodiment, the computer 21 will be described with reference to FIG. 2.

In this embodiment, inspection image data of an inspection target replica template pattern is corrected using inspection data of a master template pattern. The corrected inspection image data of the inspection target replica template pattern is compared with reference image data based on the design data of the master template pattern, thereby generating comparison data. This will be described below in detail.

An inspection image data acquisition unit 23 acquires inspection image data of an inspection target replica template pattern, as in the first embodiment. An inspection data storage unit 21e stores the inspection data (data associated with line edge roughness of the master template pattern) of the master template pattern, as in the first embodiment.

A correction unit 26 corrects the inspection image data of the inspection target replica template pattern using the inspection data of the master template pattern. The inspection target replica template pattern is formed from the master template pattern, and therefore has almost the same line edge roughness as in the master template pattern. Hence, the line edge roughness component can be removed from the inspection target replica template pattern by correcting the inspection image data of the inspection target replica template pattern using the inspection data (data associated with line edge roughness of the master template pattern) of the master template pattern.

The inspection image data (corrected inspection image data) of the inspection target replica template pattern corrected by the correction unit 26 and reference image data generated as in the first embodiment are input to a comparison data generation unit 27. That is, data obtained by performing pattern rasterization processing and filter processing for the design data stored in a design data storage unit 21d is input to the comparison data generation unit 27 as the reference image data. The comparison data generation unit 27 compares the above-described corrected inspection image data of the inspection target replica template pattern with the reference image data, thereby generating comparison data (difference image data).

A defect determination unit 28 determines a defect in the inspection target replica template pattern based on the comparison data (difference image data) generated by the comparison data generation unit 27, as in the first embodiment. In the corrected, image data (corrected inspection usage data) of the inspection target replica template pattern, the line edge roughness component is removed. The reference image data includes no line edge roughness component. Hence, if the inspection target replica template pattern has no defect, the corrected inspection image and the reference image should be almost identical. For this reason, when a difference image is generated by comparing the corrected inspection image data with the reference image data, a portion where a difference of a predetermined value or more is generated can be determined as a defective portion.

A template inspection method according to this embodiment will be described next with reference to the flowchart of FIG. 8. This inspection method is executed using the inspection device shown in FIGS. 7 and 2. Note that the basic method is the same as in the first embodiment, and a detailed description of the matters described in the first embodiment will be omitted.

First, the inspection image data of the inspection target replica template pattern is acquired, as in the first embodiment (step S21).

The correction unit 26 corrects the inspection image data of the inspection target replica template pattern using the inspection data (that is, data associated with line edge roughness of the master template) of the master template pattern (step S22).

The corrected inspection image data (corrected inspection image data) of the inspection target replica template pattern is compared with reference image data based on the design data of the master template pattern, thereby generating comparison data (step S23).

A defect in the inspection target replica template pattern is determined based on the comparison data, as in the first embodiment (step S24).

Note that the processes of steps S21 to S23 may be performed in parallel, as described in the first embodiment. That is, the comparison data may be generated while moving the inspection position.

As described above, in this embodiment as well, since defect inspection of the replica template is performed in consideration of an element such as line edge roughness that is not a true defect but may be determined as a defect, only true defects can reliably be detected, as in the first embodiment. Additionally, as in the first embodiment, since it is only necessary to store the design data of the master template and the inspection data of the master template, the stored data amount can be reduced.

Note that in this embodiment as well, a reference replica template may be used in place of the master template, and the inspection data (data associated with line edge roughness of the reference replica template pattern) of the reference replica template pattern may be used, as described in the first embodiment.

### Third Embodiment

The third embodiment will be described next. Note that the basic details are the same as in the first embodiment, and a description of the details described in the first embodiment will be omitted.

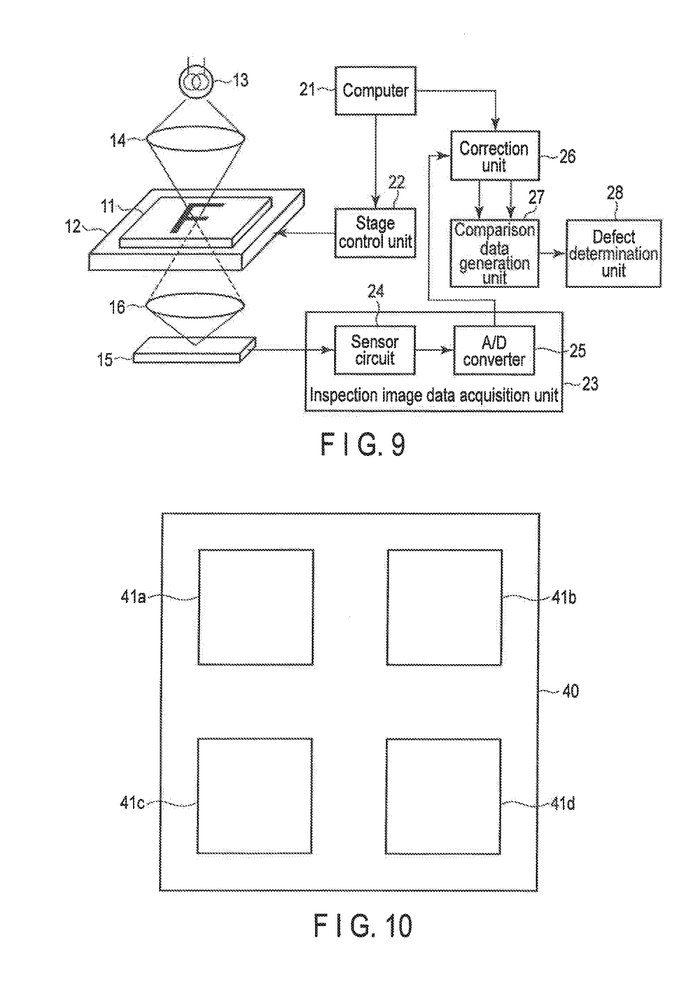

FIG. 9 is a block diagram showing the arrangement of an inspection device according to the third embodiment. Note that since the basic arrangement is the same as in FIG. 1 of the first embodiment, the same reference numerals as in the first embodiment denote constituent elements corresponding to those in the first embodiment, and a detailed description thereof will be omitted. In addition, since the basic arrangement of a computer 21 is the same as in FIG. 2 of the first embodiment, the computer 21 will be described with reference to FIG. 2.

In this embodiment, inspection image data of a plurality of inspection target replica template patterns arranged on a single inspection target replica template and having identical patterns are corrected using inspection data of a plurality of corresponding master template patterns. The corrected inspection image data of the inspection target replica template patterns are compared with each other, thereby generating comparison data. This will be described below in detail.

FIG. 10 is a view schematically showing the planar arrangement of a master template. As shown in FIG. 10, a plurality of identical master template patterns 41a, 41b, 41c, and 41d, that is, the plurality of identical die regions 41a, 41b, 41c, and 41d are normally arranged on one master template 40. An inspection data storage unit 21e stores the inspection data (data associated with line edge roughness of the master template patterns) of the master template patterns, as in the first embodiment. That is, the inspection data storage unit 21e stores the inspection data of each of the master template patterns 41a, 41b, 41c, and 41d.

Note that in the first and second embodiments as well, the plurality of identical master template patterns 41a, 41b, 41c, and 41d are arranged on one master template 40, and the inspection data storage unit 21e stores the inspection data of each of the master template patterns 41a, 41b, 41c, and 41d, as shown in FIG. 10, although not specifically mentioned in the first and second embodiments.

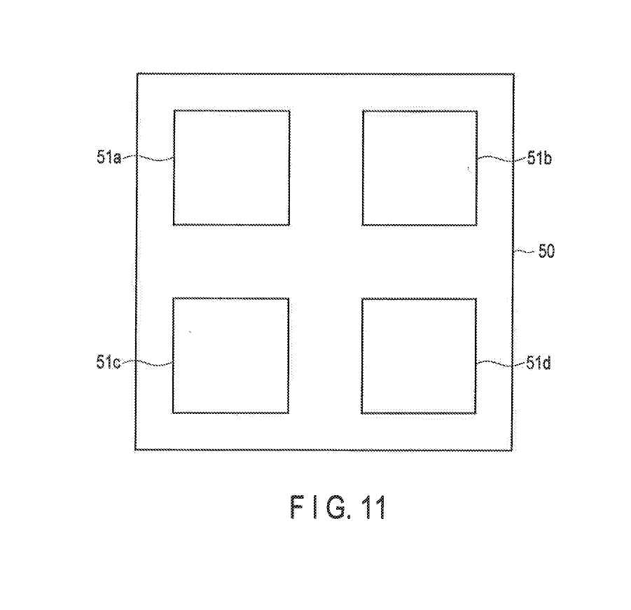

An inspection image data acquisition unit 23 acquires inspection image data of inspection target replica template patterns, as in the first embodiment. FIG. 11 is a view schematically showing the planar arrangement of a replica template. As shown in FIG. 11, a plurality of identical replica template patterns 51a, 51b, 51c, and 51d, that is, the plurality of identical die regions 51a, 51b, 51c, and 51d are arranged on one replica template 50 in correspondence with the master template patterns 41a, 41b, 41c, and 41d shown in FIG. 10.

A correction unit 26 corrects the inspection image data of the plurality of inspection target replica template patterns 51a, 51b, 51c, and 51d using the inspection data of the plurality of master template patterns 41a, 41b, 41c, and 41d, respectively. This will be described below in detail.

The inspection target replica template patterns 51a, 51b, 51c, and 51d have line edge roughness components corresponding to those in the master template patterns 41a, 41b, 41c, and 41d, respectively. Hence, using the inspection data (data associated with line edge roughness of the master template patterns) of the master template patterns 41a, 41b, 41c, and 41d stored in the inspection data storage unit 21e, the correction unit 26 corrects the inspection image data of the corresponding inspection target replica template patterns 51a, 51b, 51c, and 51d. More specifically, using the inspection data of the master template patterns 41a, 41b, 41c, and 41d, correction processing of removing the line edge roughness components included in the inspection image data of the corresponding inspection target replica template patterns 51a, 51b, 51c, and 51d is performed.

The inspection image data (corrected inspection image data) of the inspection target replica template patterns 51a, 51b, 51c, and 51d. corrected by the correction unit 26 are input to a comparison data generation unit 27. The comparison data generation unit 27 compares two arbitrary inspection image data, thereby generating comparison data (difference image data).

A defect determination unit 28 determines defects in the inspection target replica template patterns based on the comparison data (difference image data) generated by the comparison data generation unit 27, as in the first embodiment. More specifically, a defect in at least one of two inspection target replica template patterns is determined. That is, a defect in one inspection target replica template pattern may be determined based on the other inspection target replica template pattern. Alternatively, defects in both of the two inspection target replica template patterns may be determined.

The inspection target replica template patterns 51a, 51b, 51c, and 51d are formed based on the same design data, and therefore basically have the same pattern. However, since the edge roughness components of the master template patterns 41a, 41b, 41c, and 41d are different from each other, the edge roughness components of the inspection target replica template patterns 51a, 51b, 51c, and 51d are also different from each other. On the other hand, the inspection target replica template patterns 51a, 51b, 51c, and 51a are replicas of the master template patterns 41a, 41b, 41c, and 41d, respectively. For this reason, corresponding template patterns (for example, the master template pattern 41a and the replica template pattern 51a) have almost the same edge roughness. Using the inspection data (data associated with line edge roughness of the master template patterns) of the master template patterns 41a, 41b, 41c, and 41d, the inspection image data of the corresponding inspection target replica template patterns 51a, 51b, 51c, and 51d are corrected. The edge roughness components are thus removed from the inspection target replica template patterns 51a, 51b, 51c, and 51d. As a result, the image data (corrected inspection image data) of the inspection target replica template patterns 51a, 51b, 51c, and 51d after the edge roughness removal should be identical with each other. Hence, when a difference image is generated by comparing two arbitrary corrected inspection image data, a portion where a difference of a predetermined value or more is generated can be determined as a defective portion.

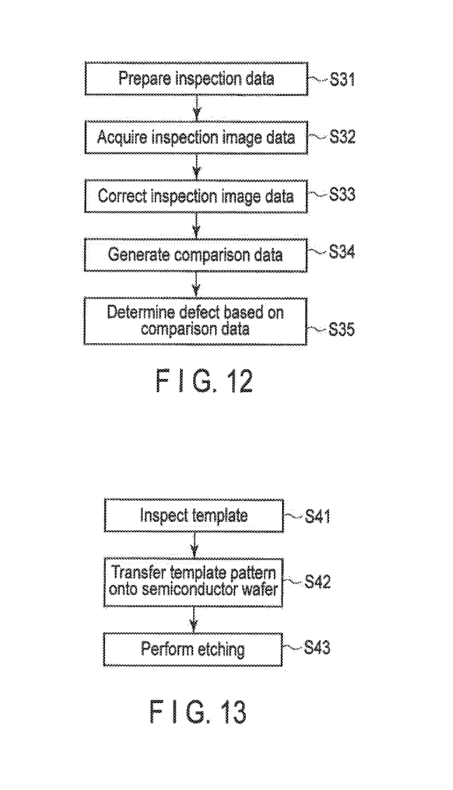

A template inspection method, according to this embodiment will be described next with reference to the flowchart of FIG. 12. This inspection method, is executed using the inspection device shown in FIGS. 9 and 2. Note that the basic method is the same as in the first embodiment, and a detailed description of the matters described in the first embodiment will be omitted.

First, the inspection image data (that is, data associated with line edge roughness of the master template) of the master template patterns are prepared (step S31). In this embodiment, the prepared inspection data are stored in the inspection data storage unit 21e.

The inspection image data of the inspection target replica template patterns are acquired, as in the first embodiment (step S32).

The correction unit 26 corrects the inspection image data of the inspection target replica template patterns using the inspection data of the master template patterns stored in the inspection data storage unit 21e (step S33).

Two arbitrary corrected inspection image data (corrected inspection image data) of the inspection target replica template patterns are compared, thereby generating comparison data (step S34). The comparison is done for all the inspection target replica template patterns.

A defect in the inspection target replica template patterns is determined based on the comparison data, as in the first embodiment (step S35).

As described above, in this embodiment as well, since defect inspection of the replica template is performed in consideration of an element such as line edge roughness that is not a true defect but may be determined as a defect, only true defects can reliably be detected, as in the first embodiment.

Pole that in the above-described embodiment, two inspection target replica template patterns arranged on a single inspection target replica template are compared. However, three or more inspection target, replica template patterns may be compared.

The device and method explained in the above-described embodiments are applicable to a semiconductor device manufacturing method. FIG. 13 is a flowchart showing the outline of such a semiconductor device manufacturing method.

First, a replica template is inspected using the above-described device and method (step S41). A template pattern is transferred onto a semiconductor wafer using the inspected replica template (step S42). Etching is performed using the transferred pattern (step S43).

Note that in the above-described embodiments, data associated with line edge roughness is used as the inspection data of the master template pattern or reference replica template pattern. However, any element other than line edge roughness may be used if the element is not a true defect but may be determined as a defect.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A template inspection, device used in imprint lithography, comprising:
an inspection image data acquisition unit configured to acquire inspection image data, of an inspection target replica template pattern based on a master template pattern, the master template pattern being arranged on a master template and also arranged on an inspection target replica template obtained from the master template;
a comparison data generation unit configured to generate comparison data by comparing the inspection image data of the inspection target replica template pattern with corrected reference image data, the corrected reference image data being obtained by correcting reference image data based on design data of the master template pattern using one of inspection data of the master template pattern and inspection data of a reference replica template pattern, and the reference replica template pattern being arranged on a reference replica template obtained from the master template and based on the master template pattern; and
a defect determination unit configured to determine a defect in the inspection target replica template pattern based on the comparison data generated by the comparison data generation unit.

2. The device of claim 1, wherein the inspection data of the master template pattern includes data associated with line edge roughness of a pattern included in the master template pattern.

3. The device of claim 2, wherein the data associated with the line edge roughness is obtained by obtaining a difference between the master template pattern and the master template pattern that has undergone filter processing.

4. The device of claim 2, wherein the data associated with the line edge roughness includes roughness data and position data of the line edge roughness.

5. The device of claim 1, wherein the inspection data of the reference replica template pattern includes data associated with line edge roughness of a pattern included in the reference replica template pattern.

6. The device of claim 1, further comprising a design data storage unit configured to store the design data of the master template pattern.

7. The device of claim 1, further comprising an inspection data storage unit configured to store one of the inspection data of the master template pattern and the inspection data of the reference replica template pattern.

8. The device of claim 1, wherein the reference image data is obtained by rasterizing the design data of the master template pattern into tone data and performing filter processing for the tone data.

9. A template inspection device used in imprint lithography, comprising:
an inspection image data acquisition unit configured to acquire inspection image data of an inspection target replica template pattern based on a master template pattern, the master template pattern being arranged on a master template and also arranged on an inspection target replica template obtained from the master template;
a correction unit configured to correct the inspection image data of the inspection target replica template pattern using one of inspection data of the master template pattern and inspection data of a reference replica template pattern, the reference replica template pattern being arranged on a reference replica template obtained from the master template and based on the master template pattern;
a comparison data generation unit configured to generate comparison data by comparing the inspection image data of the inspection target replica template pattern corrected by the correction unit with reference image data based on design data of the master template pattern; and
a defect determination unit configured to determine a defect in the inspection target replica template pattern based on the comparison data generated by the comparison data generation unit.

10. The device of claim 9, wherein the inspection data of the master template pattern includes data associated with line edge roughness of a pattern included in the master template pattern.

11. The device of claim 10, wherein the data associated with the line edge roughness is obtained by obtaining a difference between the master template pattern and the master template pattern that has undergone filter processing.

12. The device of claim 10, wherein the data associated with the line edge roughness includes roughness data and position data of the line edge roughness.

13. The device of claim 9, wherein the inspection data of the reference replica template pattern includes data associated with line edge roughness of a pattern included in the reference replica template pattern.

14. The device of claim 9, further comprising a design data storage unit configured to store the design data of the master template pattern.

15. The device of claim 9, further comprising an inspection data storage unit configured to store one of the inspection data of the master template pattern and the inspection data of the reference replica template pattern.

16. The device of claim 9, wherein the reference image data is obtained by rasterizing the design data of the master template pattern into tone data and performing filter processing for the tone data.

17. A template inspection device used in imprint lithography, comprising:
an inspection data storage unit configured to store first master template pattern inspection data of a first master template pattern and second master template pattern inspection data of a second master template pattern, the first master template pattern and the second master template pattern being arranged on a master template and having identical patterns;
an inspection image data acquisition unit configured to acquire first inspection target replica template pattern inspection image data of a first inspection target replica template pattern and second inspection target replica template pattern inspection image data of a second inspection target replica template pattern, the first inspection target replica template pattern and the second inspection target replica template pattern being arranged on an inspection target replica template obtained from the master template and based on the first master template pattern and the second master template pattern, respectively;
a correction unit configured to correct the first inspection target replica template pattern inspection image data and the second inspection target replica template pattern inspection image data using the first master template pattern inspection data and the second master template pattern inspection data, respectively;
a comparison data generation unit configured to generate comparison data by comparing the corrected first inspection target replica template pattern inspection image data with the corrected second inspection target replica template pattern inspection image data; and
a defect determination unit configured to determine a defect in at least one of the first inspection target replica template pattern and the second inspection target replica template pattern based on the comparison data generated by the comparison data generation unit.

18. The device of claim 17, wherein the first master template pattern inspection data and the second master template pattern inspection data include data associated with line edge roughness of patterns included in the first master template pattern and the second master template pattern, respectively.

19. The device of claim 18, wherein the data associated with the line edge roughness is obtained by obtaining a difference between each of the first master template pattern and the second master template pattern and a corresponding one of the first master template pattern and the second master template pattern that have undergone filter processing.

20. The device of claim 18, wherein the data associated with the line edge roughness includes roughness data and position data of the line edge roughness.
